(19) United States
(12) Patent Application Publication
(10) Pub. No.: US 2017/0357017 A1
(43) Pub. Date: Dec. 14, 2017

(54) SYSTEMS AND METHODS FOR IMPROVED COUPLING OF GEOPHYSICAL SENSORS, WHERE THE SHAFT IS OPEN AT THE FOOT AND COUPLES TO THE SENSOR BASE PLATE AT THE HEAD

(71) Applicant: CGG SERVICES SAS, Massy Cedex (FR)

(72) Inventors: Jonathan GRIMSDALE, Orsay (FR); Thomas BIANCHI, Paris (FR); Jason JUROK, East Grinstead (GB); Peter MAXWELL, Missouri City, TX (US)

(21) Appl. No.: 15/536,275

(22) PCT Filed: Nov. 24, 2015
(86) PCT No.: PCT/IB2015/002498

§ 371 Date: Jun. 15, 2017

Related U.S. Application Data
(60) Provisional application No. 62/103,163, filed on Jan. 14, 2015.

(51) Int. Cl. G01V 1/16

(52) U.S. Cl. CPC G01V 1/166; G01V 1/168

(57) ABSTRACT

A system and method for improved coupling of geophysical sensors is disclosed. The method includes determining conditions at an installation location, and selecting a sensor assembly. The sensor assembly includes a threaded device having a shaft with a foot and a head. The threaded device has a cavity that is open at the foot and extends inside the shaft from the foot to the head. The sensor assembly further includes a baseplate configured to couple to the threaded device. The method also includes preparing the installation location for installation of the selected sensor assembly and installing the selected sensor assembly at the installation location.

### CROSS-REFERENCE TO RELATED APPLICATION

This application claims the benefit under 35 U.S.C. §119(e) of U.S. Provisional Application Ser. No. 62/103,163 filed on Jan. 14, 2015, which is incorporated by reference in its entirety for all purposes.

### TECHNICAL FIELD

The present disclosure relates generally to seismic exploration tools and processes and, more particularly, to a system and method for coupling geophysical sensors.

### BACKGROUND

In the oil and gas industry, geophysical survey techniques are commonly used to aid in the search for and evaluation of subterranean hydrocarbon or other mineral deposits. Generally, a seismic energy source, or “source,” generates a seismic signal that propagates into the earth and is partially reflected by subsurface seismic interfaces between underground formations having different acoustic impedances. Geophysical or seismic detectors, or “sensors,” located at or near the surface of the earth, in a body of water, or at known depths in boreholes, record the reflections and the resulting seismic data can be processed to yield information relating to the location and physical properties of the subsurface formations. Seismic data acquisition and processing generates a profile, or image, of the geophysical structure under the earth's surface. While this profile does not provide an accurate location for oil and gas reservoirs, it suggests, to those trained in the field, the presence or absence of them.

The seismic signal is emitted in the form of a wave that is reflected off interfaces between geological layers. When the wave encounters an interface between different media in the earth's subsurface a portion of the wave is reflected back to the earth's surface while the remainder of the wave is refracted through the interface. The reflected waves are received by an array of geophones, or geophysical sensors, located at the earth's surface, which convert the displacement of the ground resulting from the propagation of the waves into an electrical signal recorded by means of recording equipment.

Measured at the surface, received waves are minuscule variations in the displacement of the ground in which sensors are placed. Due to the nature of the received waves, it is paramount that that the motion of the sensors match that of the ground. Otherwise the recorded signal is not representative of its subsurface source. Geophysical sensors are usually installed using a spike that penetrates the earth's surface to provide a mechanical coupling and to enable the shear force acting on the spike to hold the sensor firmly in place. However, spikes can be considered a safety hazard, difficult to mechanize the deployment of, and tend to make dealing with large quantities of pre-connected line segments difficult.

In certain operating environments, the native soil is either unconsolidated or relatively inelastic. Both of these features make it difficult to “couple” the sensors. In unconsolidated soil the particles are loosely bound to one another and prone to movement. The result is the absorption of the incident signal by the translated motion of the soil particles. In this situation, operators often attempt to “dig down” in search of a more solid substrate in which to mechanically attach the sensor. Inelastic soils appear to be hard, or exhibit good compressive strength, but when disturbed, even by the diameter of the sensor itself, inelastic soils become brittle. Inelastic soil is difficult to displace and the act of digging to get the sensor below the adjacent surface can cause the ground to become unconsolidated. Accordingly, the need for a mass deployment of sensors coupled with difficult terrain leaves little option to use a traditional ground spike.

Some sensors include an integrated screw thread to assist in installation. But disturbance of the terrain due to threaded devices can be detrimental to the quality of seismic coupling between the sensor and the surrounding medium. Also, because sensors are electrical devices, the attached electrical cable makes them difficult to rotate, especially when the installation process is to be mechanized.

Additionally, some sensors are installed using separate screw devices. While the act of placing a screw into the terrain seems rather trivial; there is difficulty in ensuring that the sensor can be well coupled to the terrain after the fact. Mechanically this means that the tolerances must be tight and that some form of clamping force is provided. In a typical seismic environment, these tolerances are difficult to manage or keep clean and clamping mechanisms tend to be tedious and a burden on field workers. In addition, the need for mechanization requires as few precision functions as possible.

Other installation options include placing a screw device through some opening in the sensor body where the hold down force of the screw pins the sensor to the ground (as though the sensor were a washer). Again, this type of installation entails a rather precise operation where the screw needs to be lined up with the sensors hole and the amount of drive force regulated to prevent damaging the sensor. Such a process is also difficult to mechanize.

### SUMMARY

In some embodiments, a method for deploying a geophysical sensor includes determining conditions at an installation location, and selecting a sensor assembly. The sensor assembly includes a threaded device having a shaft with a foot and a head. The threaded device has a cavity that is open at the foot and extends inside the shaft from the foot to the head. The sensor assembly further includes a baseplate configured to couple to the threaded device. The method also includes preparing the installation location for installation of the selected sensor assembly and installing the selected sensor assembly at the installation location.

In another embodiment, a geophysical sensor assembly includes a threaded device having a shaft with a foot and a head. The threaded device has a cavity that is open at the foot and extends inside the shaft from the foot to the head. The geophysical sensor assembly also includes a baseplate configured to couple to the threaded device.

In another embodiment, a method for deploying a geophysical sensor includes determining conditions at an installation location, and selecting a sensor assembly. The sensor assembly includes a shaft with a foot and a head. The shaft has a cavity that is open at the foot and extends inside the shaft from the foot to the head. The head includes a sensor and an interface. The method also includes preparing the installation location for installation of the selected sensor assembly, and installing the selected sensor assembly at the installation location.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIG. 1 illustrates an exemplary configuration of a geophysical sensor assembly that is disassembled in accordance with some embodiments of the present disclosure;

FIG. 2 illustrates an exemplary configuration of a geophysical sensor assembly that is assembled in accordance with some embodiments of the present disclosure;

FIG. 3 illustrates an exemplary cross-section of a geophysical sensor assembly in accordance with some embodiments of the present disclosure;

FIG. 4 illustrates an example geophysical sensor insertion at an installation location in accordance with some embodiments of the present disclosure;

FIG. 5 illustrates an example excavation of a level surface in accordance with some embodiments of the present disclosure;

FIG. 6 illustrates an exemplary multicomponent sensor assembly in accordance with some embodiments of the present disclosure;

FIG. 7 illustrates an example of an active sensor assembly in accordance with some embodiments of the present disclosure;

FIG. 8 illustrates an example of a collar used with the active sensor assembly of FIG. 7 in accordance with some embodiments of the present disclosure;

FIG. 9 illustrates a flow chart of example method 900 for installing geophysical sensors for seismic exploration in accordance with some embodiments of the present disclosure; and

FIG. 10 illustrates an elevation view of an example seismic exploration system configured to produce images of the earth's subsurface geological structure in accordance with some embodiments of the present disclosure.

### DETAILED DESCRIPTION

The present disclosure is directed to systems and methods for improved coupling of geophysical sensors. As discussed previously, areas of unconsolidated or relatively inelastic terrain makes installation of sensors difficult for multiple reasons. Further, insufficient mechanical coupling between the sensor and the earth's surface decreases the effectiveness or accuracy of the data collected at the geophysical sensor. In some embodiments, installation of sensors is accomplished by the use of a geophysical sensor assembly that includes a threaded device and a baseplate that can be easily coupled to the threaded device. The sensor may be affixed to the baseplate prior to coupling to the threaded device. The baseplate may be configured or oriented for a particular sensor, or may be configured or oriented to couple to multiple sizes or types of sensors. The baseplate may also be configured to attach to one or multiple configurations of threaded devices. The interface between the baseplate and the threaded device may allow adjustment of the orientation of the sensor. The particular threaded device and baseplate utilized is selected by an operator based on the terrain where the geophysical sensor is to be installed. In some surveys, the terrain across an exploration area varies. As such, the operator may select different configurations of threaded devices and baseplates for installation of geophysical sensors in different locations based on terrain variations.

In some embodiments, an active sensor assembly may be utilized that integrates the mechanism for coupling with the terrain and the sensor. The geophysical sensor and associated components are integrated into the top, or “head,” of the active sensor assembly. Each active sensor assembly may then be electronically coupled to other sensors through the use of a collar and an active string or cable. The cable may provide power and data communication to each of the active threaded devices. Thus, in some embodiments, the present disclosure assists in installation of geophysical sensors to improve mechanical coupling of the sensor with the earth's surface. Improved mechanical coupling may result in more accurate readings and data. Further, in some embodiments, the present disclosure provides installation methods for the geophysical sensors that may decrease risks to health and safety.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

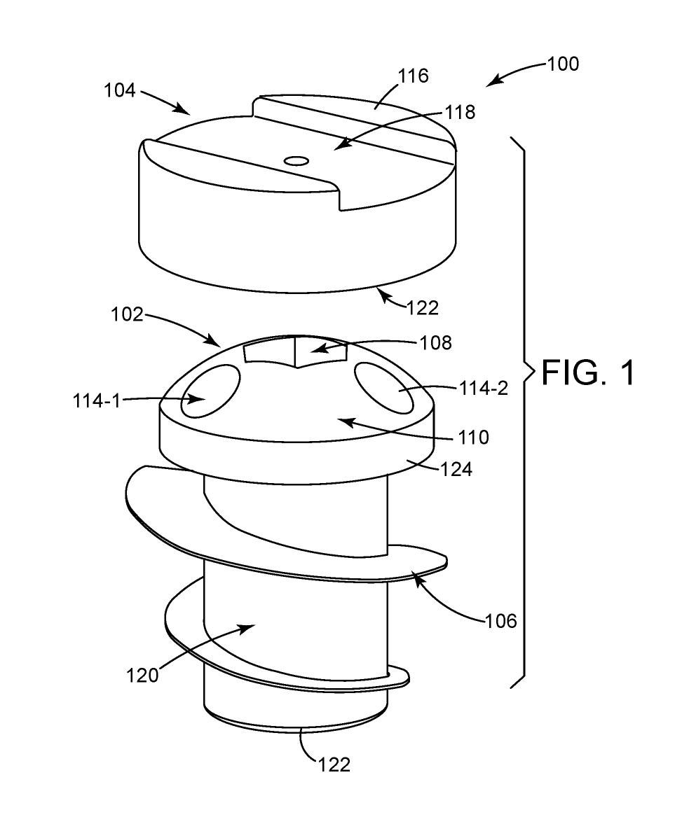

FIG. 1 illustrates an exemplary configuration of a geophysical sensor assembly that is disassembled in accordance with some embodiments of the present disclosure. In some embodiments, sensor assembly 100 includes threaded device 102 and baseplate 104. Threaded device 102 includes threads 106 to allow insertion into an installation location, such as the earth's surface. Threaded device 102 is inserted into the installation location using an insertion tool that is configured to exert the necessary force and torque to ensure that the threaded device 102 travels into the surface with minimum disturbance to the consolidation of the surrounding surface. For example, the force and torque may be applied to move threaded device 102 into the surface in a rotational step-wise manner that corresponds with threads 106 on threaded device 102. The torque and force exerted by the insertion tool is based at least in part on the configuration of threads 106 and the terrain at the installation location. A drive shaft of the insertion tool is configured to mate with tool recess 108. Although tool recess 108 is illustrated as hexagonal, tool recess 108 may be of any suitable configuration to mate with the drive shaft of the insertion tool.

In some embodiments, threads 106 are configured based on the terrain conditions of the installation location and based on minimum disruption of the terrain during insertion. The pitch of threads 106 are also configured to minimize disturbance of the installation location during vertical movement of the threaded device 102 into the surface. For example, if the terrain at the installation location is substantially unconsolidated, such as sandy soil, threads 106 may include wider paddles or helical ridges and may include a lower pitch. As another example, if the terrain is substantially inelastic, consolidated, or packed, threads 106 may include narrower helical ridges and a higher pitch. Following installation of threaded device 102 into the installation location, additional degrees of rotation may be applied by the insertion tool to ensure a positive downward force is exerted by the surrounding surface on threaded device 102.

In some embodiments, coupling between threaded device 102 and baseplate 104 may be via magnetic coupling. As such, one or both of threaded device 102 and baseplate 104 is constructed of materials that facilitate magnetic coupling between top surface 110 of threaded device 102 and bottom surface 112 of baseplate 104. For example, threaded device 102 or baseplate 104 may be constructed of any ferromagnetic material, such as metal, a hard plastic that includes magnetic material or particles, or any other suitable material that allows for magnetic coupling. In some embodiments, threaded device 102 may be constructed of a material without magnetic properties, such as hard plastic or aluminum. In some embodiments, threaded device 102 or baseplate 104 are constructed with a material of sufficient hardness or stiffness to minimize or eliminate any resonances at frequencies within the frequencies of the seismic band. Further, threaded device 102 is constructed of a material that withstands insertion at the installation location without substantial deformation. Additionally, threaded device 102 is constructed of a material that facilitates mechanical coupling to the terrain of the earth's surface at the installation location. In some embodiments, each of threaded device 102 or baseplate 104 may be constructed of two or more materials with one material having magnetic properties, for example, a thin ferromagnetic plate.

Magnets or magnetic material in threaded device 102 and baseplate 104 may assist in the insertion and removal of sensor assembly 100. For example, magnetic material assists in retaining threaded device 102 on a drive shaft of the insertion tool as threaded device 102 is inserted at the installation location. As another example, during removal, the magnetic field generated by threaded device 102 and baseplate 104 may be sensed to locate sensor assembly 100 and also utilized to fasten sensor assembly 100 to an extraction tool.

Given the tolerance requirements of a simple mechanical fastening system and the installation environment, such as a harsh desert, magnetic coupling between threaded device 102 and baseplate 104 may be optimal due to no moving parts and blind assembly capabilities.

To facilitate magnetic coupling, in some embodiments, threaded device 102 may include one or more cavities 114-1 and 114-2 for housing one or more magnets. The magnets are construed of strong, rare earth magnets, other magnetic metals, ferrites, or alloys that exhibit ferromagnetic properties to provide the sufficient magnetic coupling force with baseplate 104, or other component as appropriate. Although cavities 114-1 and 114-2 illustrate the installation of similarly sized magnets, any suitable number and size of magnets may be utilized in any suitable orientation or location with respect to the structure in which they are configured. For example, one larger cavity 114 and associated magnet may be utilized in place of cavities 114-1 and 114-2 and associated magnets to couple threaded device 102 and baseplate 104.

In addition to providing the coupling force between threaded device 102 and baseplate 104, the magnets, or magnetic elements, may also be used to ensure a specific alignment, vertical and horizontal, between threaded device 102 and baseplate 104. In instances where the installation of threaded devices 102 is mechanized, both threaded device 102 and baseplate 104 may utilize the same type of magnetic element (but polar opposites) and threaded device 102 and baseplate 104 may be automatically aligned.

Although discussed with respect to magnetic coupling, in some embodiments, other coupling mechanisms between threaded device 102 and baseplate 104 are utilized. For example, baseplate 104 may be substantially affixed to threaded device 102 via screws, fasteners, welds, adhesive, or any other suitable fastening mechanism. The coupling force may be sufficient to maintain the mechanical integrity of the interfaces between the components of the geophysical sensor assembly. Mechanical integrity may refer to the need to minimize or eliminate any movement of components of the geophysical sensor assembly relative to each other that allow the components to become loose, rattle, or otherwise individually move.

In some embodiments, shaped interfaces to provide improved mechanical coupling at the interfaces between components of sensor assembly 100 are used in addition to the magnetic coupling. In some embodiments, threaded device 102 includes top surface 110 of head 124 having a convex shape that is substantially domed, conical, or hemi-spherical. The domed, conical, or hemi-spherical shape of top surface 110 assists in shedding sand or other debris and allow for adjustment of baseplate 104. For example, if threaded device 102 is installed in the surface such that it is not oriented directly vertical, the domed, conical, or hemi-spherical shape of top surface 110 allows adjustment of baseplate 104 to compensate for the orientation of threaded device 102, both vertically and azimuthally. As such, bottom surface 112 of baseplate 104 has a concave surface configured to couple with top surface 110 of threaded device 102. Use of a domed, conical, or hemi-spherical shape for top surface 110 enables coupling of threaded device 102 and baseplate 104 without significant human interaction or precision assemblies. Further, although the interface between threaded device 102 and baseplate 104 is illustrated and described using a domed, conical, or hemi-spherical shape, the surface at the interface may be of any shape or structure that provides for coupling and may improve structural integrity of the interface.

As illustrated in FIG. 1, shaft 120 of threaded device 102 may be substantially cylindrically shaped and foot 122 of threaded device 102 may be substantially flat. In some embodiments, shaft 120 may be configured in any suitable shape, for example, shaft 120 may be tapered from head 124 to foot 122. Additionally, foot 122 may be configured in any suitable shape. For example, foot 122 may have a convex shape or may include teeth, flanges, or spikes as suitable for the particular implementation.

In some embodiments, top surface 116 of baseplate 104 may include channel 118. Channel 118 may be of any size or configuration to allow installation of a sensor. In some embodiments, top surface 116 of baseplate 104 may not include channel 118 and may be substantially flat. The configuration of top surface 116 is arranged per the specific implementation or specific sensor that is coupled to baseplate 104.

Although discussed with reference to geophysical sensors, sensor assembly 100 may be used for insertion of any device employed to determine a property at the installation location. For example, sensor assembly 100 may be utilized with soil content measurement devices, sea level measurement devices, or any other suitable devices. Additionally, an operator selects a particular configuration of sensor assembly 100 based on the necessary mechanical coupling force, the orientation of the assembly with respect to the terrain at the installation location, the need to interchange or exchange the components for use at another location, characteristics of the terrain at the installation location, or any other suitable factor based on the specific implementation.

Embodiments of the present disclosure are suited for deployment in land surveys or ocean bottom surveys. In ocean bottom implementations, sensor assembly 100 may be encased in plastic or other substantially waterproof or water resistant material.

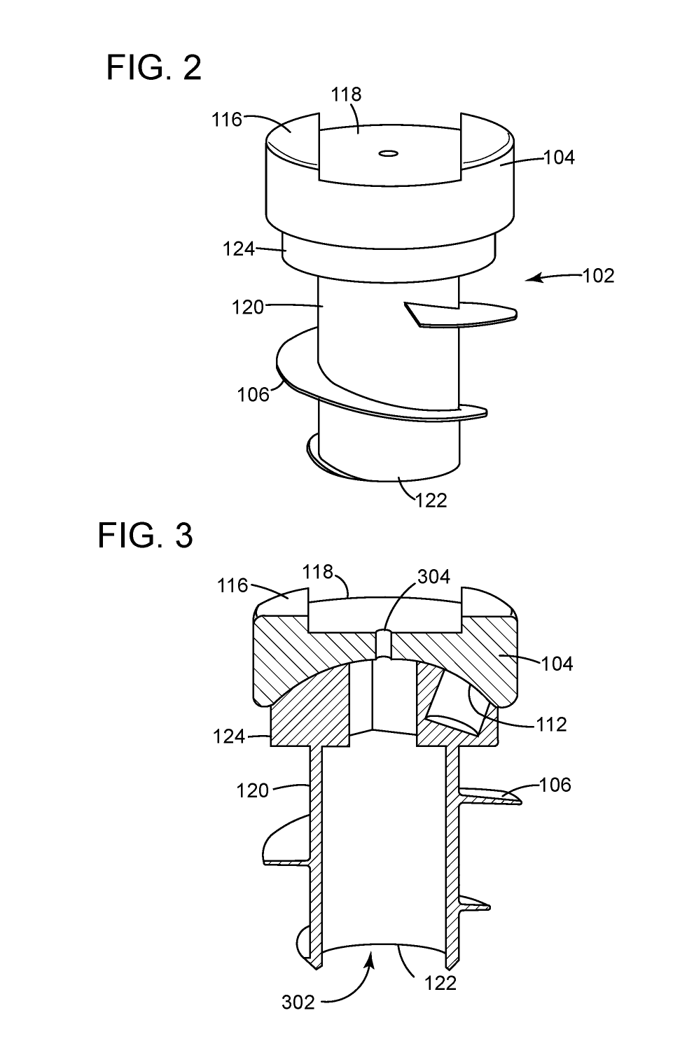

FIG. 2 illustrates an exemplary configuration of a geophysical sensor assembly that is assembled in accordance with some embodiments of the present disclosure. Sensor assembly 100 is shown with baseplate 104 coupled to the top of threaded device 102. Using magnetic coupling, the present disclosure minimizes or eliminates the need for tools or special fixtures to accomplish modifications in the field. Further, the present disclosure maintains a low level of mechanical complexity based on the lack of moving parts. With respect to forces experienced by the geophysical sensor assembly, the use of magnetic coupling and shaped interfaces provides a single fastening point approximately in the center of the interfaces. A single fastening point reduces or eliminates any resultant asymmetrical forces that may result from an imbalance in forces related to having multiple fasteners.

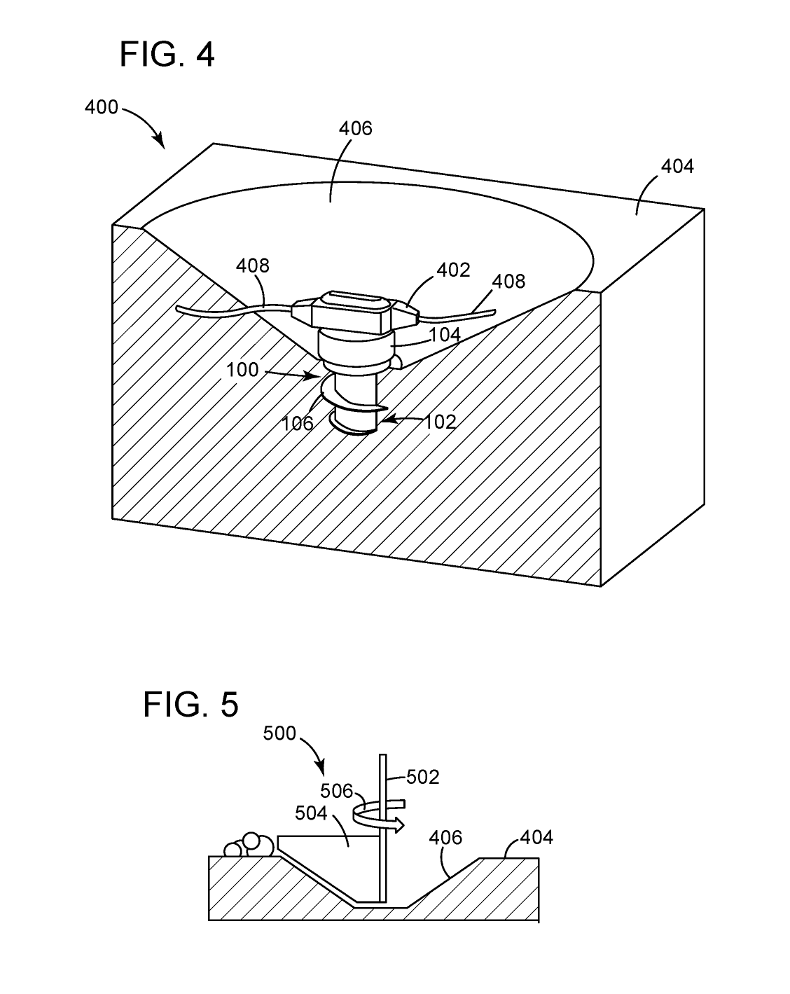

FIG. 3 illustrates an exemplary cross-section of a geophysical sensor assembly in accordance with some embodiments of the present disclosure. Threaded device 102 includes cavity 302 extending substantially through the center of threaded device 102 from foot 122 to head 124. Accordingly, at foot 122, threaded device 102 is substantially open. Cavity 302 creates a hollow opening extending partially through threaded device 102. Use of cavity 302 assists in ensuring that disturbance to the installation surface is minimized during insertion of threaded device 102. During insertion of threaded device 102, cavity 302 may be filled with soil or other material present at the installation location. The thickness of shaft 120 that encompasses cavity 302 is based on the force or torque required to insert sensor assembly 100 at the installation location. For example, the thickness of shaft 120 is sufficient such that threaded device 102 is able to withstand the force or torque required for insertion with insubstantial deformation. Moreover, threaded device 102 may be construction of biodegradable or environmentally neutral materials.

In some embodiments, opening 304 extends substantially through baseplate 104 to allow coupling to a sensor by means of a screw or rivet. Opening 304 may be countersunk on bottom surface 112 of baseplate 104 to allow for improved coupling between baseplate 104 and threaded device 102. Opening 304 may be a threaded hole, partially threaded or may have a smooth surface based on the requirements of the specific implementation.

FIG. 4 illustrates an example geophysical sensor insertion at an installation location in accordance with some embodiments of the present disclosure. Insertion 400 includes sensor assembly 100 coupled with sensor 402. In some embodiments, sensor assembly 100 and sensor 402 are installed directly into level surface 404. In some embodiments, level surface 404 is excavated prior to installation.

For example, FIG. 5 illustrates an example excavation of a level surface in accordance with some embodiments of the present disclosure. Rotating shovel 500 includes axis 502 and blade 504. In operation, rotation shovel 500 is rotated in a direction shown by arrow 506. Blade 504 may be tapered or may be of any other suitable configuration to create recess 406. Rotating shovel 500 creates recess 406 in level surface 404.

Returning to FIG. 4, recess 406 allows installation of sensor assembly 100 and sensor 402 below level surface 404. Recessed installation of sensor 402 minimizes noise caused by wind or other environmental effects on signals received or recorded by sensor 402. Additionally, after installation, the top surface of sensor 402 may be covered by dirt, sand, or other debris that was previously removed during excavation. For example, during excavation, cuttings from recess 406 are deposited on the outside perimeter of the hole. A vacuum system may be used to pick up the cuttings created during creation of recess 406, and deposit the cuttings on and around sensor 402 after sensor assembly 100 and sensor 402 are installed.

In some embodiments, cables 408 are coupled and extend from sensor 402 to connect sensor 402 with other sensors or a computing system. Cables 408 may provide for power, data, and communication. In some embodiments, recess 402 is sized and configured such that cables 408 coupled to sensor 402 gently slope up and out. Although discussed with cables 408 coupling sensors 402, any suitable method may be utilized for providing power, data, or communications between and among sensors 402. For example, power may be supplied by a battery and communication may be supplied by an antenna or other wireless communication protocol.

Sensor 402 is any suitable device that measures or detects a property of the surface or subsurface. In some embodiments, sensor 402 is any type of instrument that is operable to transform seismic energy or vibrations into a voltage signal. For example, sensor 402 may be a vertical, horizontal, or multicomponent geophone, accelerometers, or optical fiber with wire or wireless data transmission, such as a three component (3C) geophone, a 3C accelerometer, or a 3C Digital Sensor Unit (DSU). Multiple sensors 402 may be utilized within an exploration area to provide data related to multiple locations and distances from seismic sources. Sensors 402 may be positioned in multiple configurations, such as linear, grid, array, or any other suitable configuration.

During installation, threaded device 102 is inserted at an installation location that may have been excavated to form a recess 406. Threaded device 102 is inserted using an insertion tool that screws threaded device 102 into the installation location. The insertion tool exerts the necessary force and torque to ensure that threaded device 102 moves into the media at the installation location with as little disturbance of the consolidation of the surrounding media as possible. As such, the required force and torque are associated in such a way that threaded device 102 moves downward into the media with the same step as the threads 106 on threaded device 102. Use of an insertion tool allows measurement of the torque and downward pressure (or force) required to insert threaded device 102. The torque and force required may be recorded for each sensor installation location, and may be used to map very near surface conditions by establishing a correlation between the mechanical measurements and geophysical properties, such as, P-wave and S-wave velocity, absorption, or other suitable characteristics.

Multiple sensors 402 may be individually attached to baseplates 104 prior to coupling the baseplates 104 with threaded devices 102. Then, each of baseplates 104 are coupled to threaded devices 102. Installation of sensors 402 may include covering sensors 402 with soil, a sand bag, or other material or structure, to reduce or substantially prevent wind noise and improve mechanical coupling with the earth's surface. Soil may be gathered from nearby terrain or from the creation of recesses 406 for placement of sensors 402.

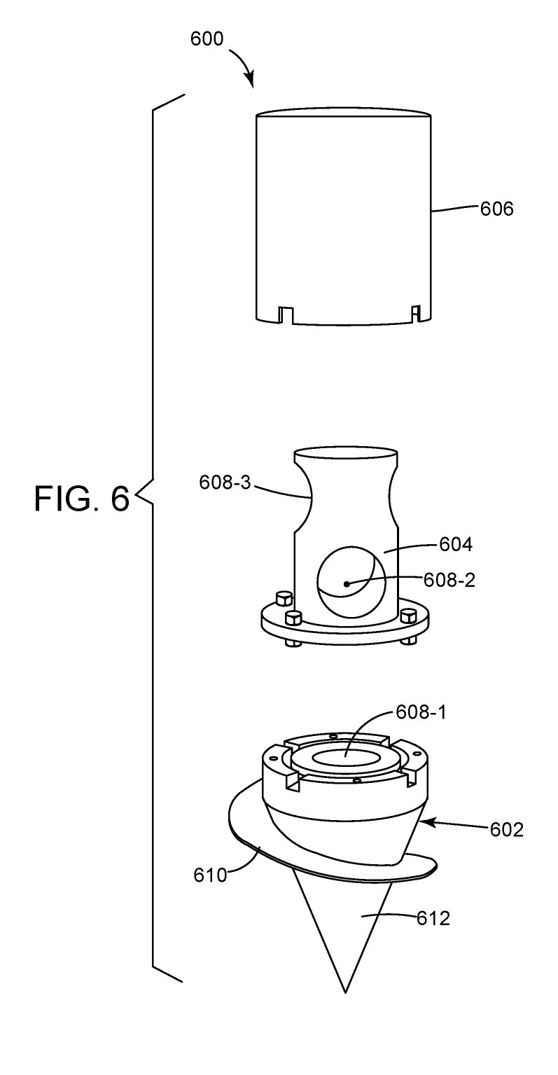

FIG. 6 illustrates an exemplary multicomponent sensor assembly in accordance with some embodiments of the present disclosure. In multicomponent sensor assembly 600, a sensor may be placed inside threaded device 602. Including a sensor in threaded device 602 may reduce or minimize the vertical component of rotation of threaded device 602. Rotation of the sensor can provoke an unwanted vertical component of the media movement if rotation is about any axis which is not at the center of the sensor. Placing the center of the sensor at the center of threaded device 602 may mitigate this problem (often called “rocking” by those skilled in the art). Portions or all of multicomponent sensor assembly 600 may be utilized in combination with portions of sensor assembly 100, discussed with reference to FIGS. 1 through 5.

Assembly 600 may include threaded device 602, receptacle 604, and cover 606. Threaded device 602 may include one cavity 608-1 for retaining a sensor. Receptacle 604 may include cavities 608-2 and 608-3 for retaining a sensor each. Each of cavities 608 is configured to be orthogonal to other cavities 608.

Threaded device 602 includes threads 610 to allow insertion into an installation location, such as the earth's surface. Threaded device 602 may be inserted into the installation location using an insertion tool that is configured to exert the necessary force and torque to ensure that the threaded device 602 travels into the surface with minimum disturbance to the consolidation of the surrounding surface. For example, the force and torque is applied to move threaded device 602 into the surface in a rotational step-wise manner that corresponds with threads 610 on threaded device 602. The torque and force exerted by the insertion tool is based at least in part on the configuration of threads 610 and the terrain at the installation location.

In some embodiments, threads 610 are configured based on the terrain conditions of the installation location and based on minimum disruption of the terrain during insertion. The pitch of threads 610 are configured to minimize disturbance of the installation location during vertical movement of the threaded device 602 into the surface. For example, if the terrain at the installation location is substantially unconsolidated, such as sandy soil, threads 610 may include wider helical ridges and may include a lower pitch. As another example, if the terrain is substantially inelastic, consolidated, or packed, threads 610 may include narrower helical ridges and a higher pitch. Following installation of threaded device 602 into the installation location, additional degrees of rotation may be applied by the insertion tool to ensure a positive downward force is exerted by the surrounding surface on threaded device 602.

In some embodiments, any of threaded device 602, receptacle 604, and cover 606 may be constructed of a material without magnetic properties, such as hard plastic or aluminum. In some embodiments, threaded device 602, receptacle 604, and cover 606 are constructed with a material of sufficient hardness or stiffness to minimize or eliminate any resonances at frequencies within the frequencies of the seismic band. Further, threaded device 602 is constructed of a material that withstands insertion at the installation location without substantial deformation. Additionally, threaded device 602 is constructed of a material that facilitates mechanical coupling to the terrain of the earth's surface at the installation location. In some embodiments, each of threaded device 602, receptacle 604, and cover 606 may be constructed of two or more materials.

Although discussed with respect to magnetic coupling, in some embodiments, other coupling mechanisms between threaded device 602, receptacle 604, and cover 606 may be utilized. For example, receptacle 604 may be substantially affixed to threaded device 602 via screws, fasteners, welds, adhesive, or any other suitable fastening mechanism. The coupling force may be sufficient to maintain the mechanical integrity of the interfaces between the components of the multicomponent sensor assembly. Mechanical integrity may refer to the need to minimize or eliminate any movement of components of the multicomponent sensor assembly relative to each other that allow the components to become loose, rattle, or otherwise individually move.

As illustrated in FIG. 6, shaft 612 of threaded device 602 may be substantially conically shaped. In some embodiments, shaft 612 may be configured in any suitable shape, for example, shaft 612 may be tapered or may be cylindrically shaped.

Although discussed with reference to multicomponent sensors, assembly 600 may be utilized for insertion of any device utilized to determine a property at the installation location. For example, assembly 600 may be utilized with soil content measurement devices, sea level measurement devices, or any other suitable devices. Additionally, the selection of a particular configuration of assembly 600 may be based on the necessary mechanical coupling force, the orientation of the assembly with respect to the terrain at the installation location, the need to interchange or exchange the components for use at another location, characteristics of the terrain at the installation location, or any other suitable factor based on the specific implementation.

Embodiments of the present disclosure may be suited for deployment in land surveys or ocean bottom surveys. In ocean bottom implementations, multicomponent sensor assembly 600 may be encased in plastic or other substantially waterproof or water resistant material.

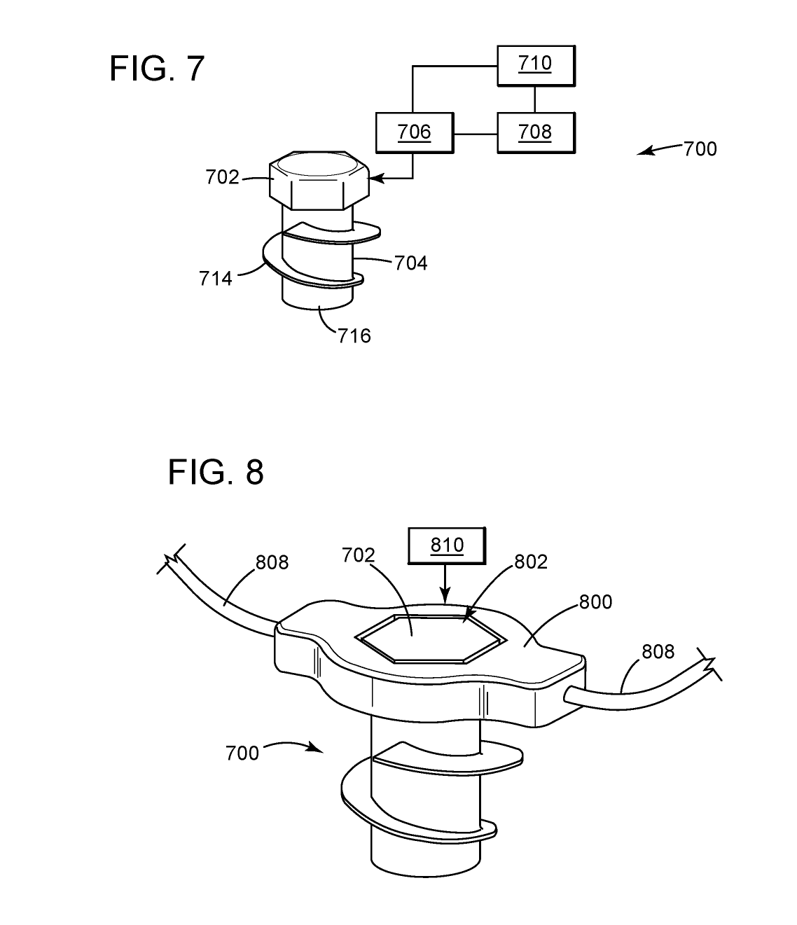

FIG. 7 illustrates an example of an active sensor assembly in accordance with some embodiments of the present disclosure. Active sensor assembly 700 includes head 702 and shaft 704. Head 702 includes sensor 706 and associated components 708 including, for example, a digitizing unit, a radio frequency identification (RFID) tag, a light emitting diodes (LEDs) to indicate unit status, a memory, an antenna, and other suitable components. Head 702 may also include interface 710 for communicating with a collar (discussed with reference to FIG. 8). Configuring sensor 706 inside head 702 minimizes the number of components and complexity of the sensor assembly.

Active sensor assembly 700 includes threads 714 on shaft 704 to allow insertion into an installation location, such as the earth's surface. Active sensor assembly 700 is inserted into the installation location using an insertion tool that is configured to exert the necessary force and torque to ensure that the active sensor assembly 700 travels into the surface with minimum disturbance to the consolidation of the surrounding surface. For example, the force and torque may be applied to move active sensor assembly 700 into the surface in a rotational step-wise manner that corresponds with threads 714 on shaft 704. The torque and force exerted by the insertion tool is based at least in part on the configuration of threads 714 and the terrain at the installation location. A drive shaft of the insertion tool is configured to mate with head 704. Although head 704 is illustrated as hexagonal, head 704 may be of any suitable configuration to mate with the drive shaft of the insertion tool.

In some embodiments, threads 714 may be configured based on the terrain conditions of the installation location and based on minimum disruption of the terrain during insertion. The pitch of threads 714 are configured to minimize disturbance of the installation location during vertical movement of the active sensor assembly 700 into the surface. For example, if the terrain at the installation location is substantially unconsolidated, such as sandy soil, threads 714 may include wider helical ridges and may include a lower pitch. As another example, if the terrain is substantially inelastic, consolidated, or packed, threads 714 may include narrower helical ridges and a higher pitch. Following installation of active sensor assembly 700 into the installation location, additional degrees of rotation may be applied by the insertion tool to ensure a positive downward force is exerted by the surrounding surface on active sensor assembly 700.

Active sensor assembly 700 may be constructed of hard plastic, aluminum or any other non-metallic or otherwise suitable material. In some embodiments, active sensor assembly 700 is constructed with a material of sufficient hardness or stiffness to minimize or eliminate any resonances at frequencies within the frequencies of the seismic band. In some embodiments, active sensor assembly 700 is constructed of a material that withstands insertion at the installation location without substantial deformation. Additionally, active sensor assembly 700 may be constructed of a material that facilitates mechanical coupling to the terrain of the earth's surface at the installation location.

Shaft 704 of active sensor assembly 700 may be substantially cylindrically shaped and foot 716 of active sensor assembly 700 may be substantially flat. In some embodiments, shaft 704 may be configured in any suitable shape, for example, shaft 704 may be tapered from head 702 to foot 716. Additionally, foot 716 may be configured in any suitable shape. For example, foot 716 may have a convex shape or may include teeth, flanges, or spikes as suitable for the particular implementation.

Active sensor assembly 700 includes a cavity extending substantially through the center of the shaft 704 of active sensor assembly 700 from foot 716 to head 702. The cavity creates a hollow opening extending partially through active sensor assembly 700. Use of a cavity assists in ensuring that disturbance to the installation surface is minimized during insertion of active sensor assembly 700. The thickness of shaft 704 that encompasses the cavity is based on the force or torque required to insert active sensor assembly 700 at the installation location. For example, the thickness of shaft 704 may be sufficient such that active sensor assembly 700 is able to withstand the force or torque required for insertion with insubstantial deformation.

In some embodiments, head 702 includes sensor 706. Sensor 706 is any suitable device that measures or detects a property of the surface or subsurface. In some embodiments, sensor 706 may be any type of instrument that is operable to transform seismic energy or vibrations into a voltage signal. For example, sensor 706 may be a vertical, horizontal, or multicomponent geophone, accelerometers, or optical fiber with wire or wireless data transmission, such as a three component (3C) geophone, a 3C accelerometer, or a 3C Digital Sensor Unit (DSU). Multiple sensors 706 may be utilized within an exploration area to provide data related to multiple locations and distances from seismic sources. Sensors 706 arranged in heads 702 may be positioned in multiple configurations, such as linear, grid, array, or any other suitable configuration. Additionally, in some embodiments, head 702 includes interface 710 communicatively coupled to sensor 706 and components 708. Interface 710 may be configured to communicate with and receive power from a collar, discussed with reference to FIG. 8.

FIG. 8 illustrates an example of a collar used with the active sensor assembly of

FIG. 7 in accordance with some embodiments of the present disclosure. Collar 800 is configured to fit over head 702 of active sensor assembly 700. For example, collar 800 may include an opening 802 that mates with the exterior surfaces of head 702. Additionally, head 702 may be tapered to facilitate a snug but relatively easily removable mating between collar 800 and head 702. In some embodiments, cables 808 are coupled to and extend from collar 800 to connect sensor 706 with other sensors or a computing system. Cables 808 may provide for power, data, and communication. Additionally, in the event of a communication failure with sensor 706, the collar 800 using cables 808 may maintain connectivity with adjacent sensors until repairs can be made.

Collar 800 may include interface 810 that wirelessly communicates with interface 710 configured on head 702. As such, interface 810 is communicatively coupled to interface 710. For example, interfaces 810 and 710 may be contacts, connectors, RFID links, spring loaded contacts, contact strips, or other suitable method for accomplishing wireless power transfer and data communication. Coupling between interfaces 810 and 710 may provide a robust and wireless data link, and method for providing power to sensor 706. Because of the mechanical fit between interfaces 810 and 710, the communication and power transfer between collar 800 and active sensor assembly 700 may continue in both wet and dry or abrasive environments. Further, since collar 800 is separate from active sensor assembly 700, high voltage discharges (static/lightning) may be prevented from damaging sensor 706. Additionally, in some embodiments, collar 800 may be a ring or any other suitable detachable device.

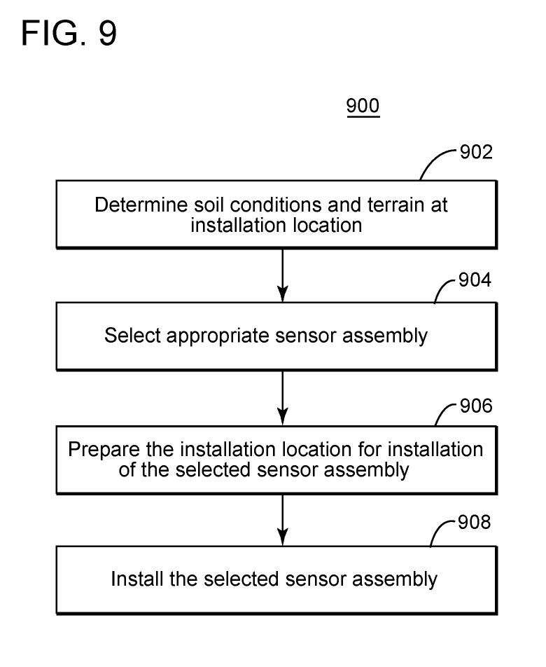

FIG. 9 illustrates a flow chart of example method 900 for installing geophysical sensors for seismic exploration in accordance with some embodiments of the present disclosure. The method 900 begins at step 902, where an operator determines the soil conditions and terrain at a location for installation of a geophysical sensor in an exploration area for a seismic survey.

At step 904, the operator selects, based on the terrain, the appropriate sensor assembly. For example, geophysical sensor assembly 100 discussed with reference to FIGS. 1 through 5, multicomponent sensor assembly 600 discussed with reference to FIG. 6, active sensor assembly 700 discussed with reference to FIGS. 7 and 8, or any suitable combination may be selected for use. Any of the configurations of FIGS. 1 through 8 may be utilized based on the need for improved mechanical coupling between the geophysical sensor and the earth's surface, the availability or cost of any particular assembly, or the ease of installation of a particular assembly. The operator may further based the selection of the sensor assembly based on thread configuration as it relates to the terrain at the installation location, as discussed with reference to FIGS. 1, 6 and 7.

At step 906, the operator prepares the installation location for installation of the selected sensor assembly. For example, an excavation tool may be utilized to create a cavity for the installation of the selected sensor assembly as discussed with reference to FIGS. 4 and 5.

At step 908, the operator installs the selected sensor assembly. For example, an insertion tool that is configured to mate with a portion of the selected sensor assembly may be utilized for installation. With reference to FIGS. 1 through 5, the operator may install threaded device 102. Then, baseplate 104 affixed to a sensor 402 may be coupled to the installed threaded device 102. Using threaded device 102 and a specialized insertion tool that is able to exert the necessary force and torque may ensure that threaded device 102 moves into the installation location with as little disturbance of the consolidation of the surrounding media as possible. For example, the insertion tool may couple the force and torque in such a way that the tool moves downward into the media with the same step as the thread on threaded device 102. The insertion tool may allow measurement of the torque and downward pressure required to insert threaded device 102. Such measurements may be recorded for each sensor position, and may be used to map very near surface conditions by establishing a correlation between the mechanical measurements and geophysical properties such as ground or surface wave velocity, absorption, and other suitable parameters. At the end of the insertion process, a few extra degrees of rotation may be added, in order to secure a positive downward force being exerted by the media on the device. With reference to FIG. 6, threaded device 602, receptacle 604, and cover 606 may be installed. Receptacle 604 and cover 606 may be coupled prior to attaching to threaded device 602, which may include a tapered interface or may include sensors on a vertical axis protruding into threaded device 602. With reference to FIGS. 7 and 8, the operator may install active sensor assembly 700. Then collar 800 may be coupled to active sensor assembly 700, and interface 810 may be communicatively coupled to interface 710. Further, the operator may cover the selected sensor assembly with dirt, debris, or any other suitable material to minimize noise from wind and the environment.

Modifications, additions, or omissions may be made to method 900 without departing from the scope of the present disclosure. For example, the order of the steps may be performed in a different manner than that described and some steps may be performed at the same time. For example, step 906 may be performed before step 904. Additionally, each individual step may include additional steps without departing from the scope of the present disclosure. Further, more steps may be added or steps may be removed without departing from the scope of the disclosure.

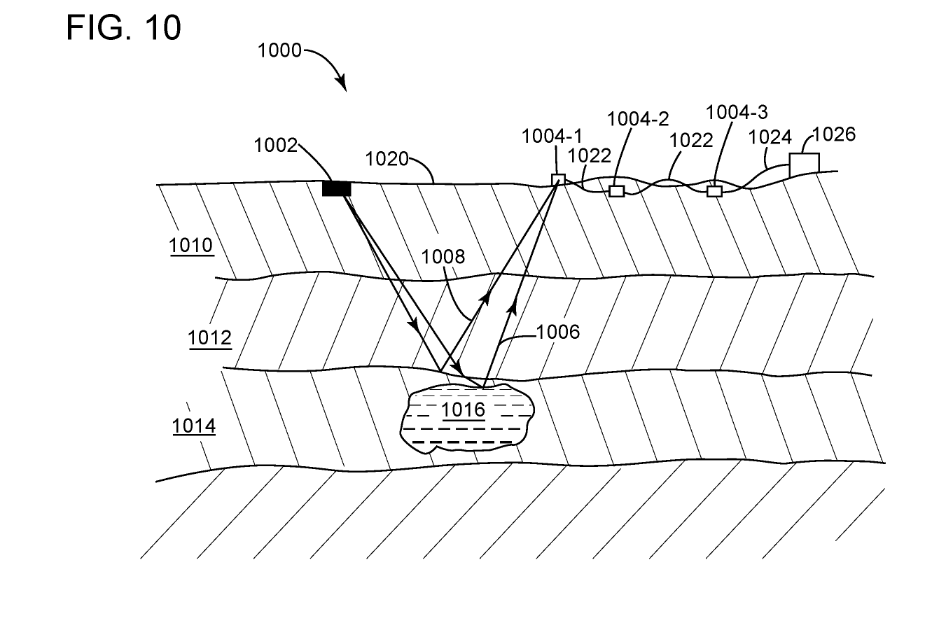

FIG. 10 illustrates an elevation view of an example seismic exploration system configured to produce images of the earth's subsurface geological structure in accordance with some embodiments of the present disclosure. The images produced by system 1000 allow for the evaluation of subsurface geology. System 1000 may include one or more seismic energy sources 1002 and one or more sensors 1004 which are located within a pre-determined exploration area. The exploration area may be any defined area selected for seismic survey or exploration. Survey of the exploration area may include the activation of seismic source 1002 that radiates an acoustic wave field that expands downwardly through the layers beneath the earth's surface. The seismic wave field is then partially reflected from the respective layers and recorded by sensors 1004. For example, source 1002 generates seismic waves and geophysical sensors 1004 records rays 1006 and 1008 reflected by interfaces between subsurface layers 1010, 1012, and 1014, oil and gas reservoirs, such as target reservoir 1016, or other subsurface structures.

Seismic energy source 1002 may be referred to as an acoustic source, seismic source, energy source, and source 1002. In some embodiments, source 1002 is located on or proximate to surface 1020 of the earth within an exploration area. Source 1002 may be operated by a central controller that coordinates the operation of several sources 1002. Further, a positioning system, such as a global positioning system (GPS), may be utilized to locate and time-correlate sources 1002 and sensors 1004. Source 1002 may comprise any type of seismic device that generates controlled seismic energy, such as a seismic vibrator, vibroseis, dynamite, an air gun, a thumper truck, or any other suitable seismic energy source.

Sensors 1004 may be located on or proximate to surface 1020 of the earth within an exploration area. For example, sensor 1004-1 may be located on the surface 1020 while sensors 1004-2 and 1004-3 may be located in a recess created by an excavation tool. Sensors 1004 may be any type of instrument that is operable to transform seismic energy or vibrations into a voltage signal. For example, sensors 1004 may be vertical, horizontal, or multicomponent geophone, accelerometers, or optical fiber with wire or wireless data transmission, such as a three component (3C) geophone, a 3C accelerometer, or a 3C Digital Sensor Unit (DSU). Multiple sensors 1004 may be utilized within an exploration area to provide data related to multiple locations and distances from sources 1002. Sensors 1004 may be positioned in multiple configurations, such as linear, grid, array, or any other suitable configuration. In some embodiments, geophysical sensors 1004 may be positioned along one or more cables or strings 1022. Each sensor 1004 is typically spaced apart from adjacent sensors 1004 in the string 1022.

Spacing between sensors 1004 in string 1022 may be approximately the same preselected distance, or span, or the spacing may vary depending on a particular application, exploration area topology, or any other suitable parameter. Each of sensor 1004 may include all or portions of any of the sensor assemblies discussed with reference to FIGS. 1 through 8.

One or more sensors 1004 transmit raw seismic data from reflected seismic energy via network 1024 to computing unit 1026. Computing unit 1026 may perform seismic data processing on the raw seismic data to prepare the data for interpretation, and may also be configured to control sensors 1004. Computing unit 1026 may include any instrumentality or aggregation of instrumentalities operable to compute, classify, process, transmit, receive, store, display, record, or utilize any form of information, intelligence, or data. For example, computing unit 1026 may include one or more personal computers, storage devices, servers, or any other suitable device and may vary in size, shape, performance, functionality, and price.

Network 1024 may be configured to communicatively couple one or more components of system 1000. For example, network 1024 may communicatively couple sensors 1004 with computing unit 1026. Further, network 1024 may communicatively couple a particular sensor 1004 with other sensors 1004. Network 1024 may be any type of network that provides communication, such as one or more of a wireless network, a local area network (LAN), or a wide area network (WAN), such as the Internet.

This disclosure encompasses all changes, substitutions, variations, alterations, and modifications to the example embodiments herein that a person having ordinary skill in the art would comprehend Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a geophysical sensor does not have to be turned on but must be configured to receive reflected energy.

Embodiments of the disclosure may also relate to an apparatus for performing the operations herein. This apparatus may be specially constructed for the required purposes. Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the disclosure is defined by the appended claims.

What is claimed is:

1. A method for deploying a geophysical sensor, comprising:
determining conditions at an installation location;
selecting a sensor assembly, the sensor assembly including:
a threaded device having a shaft with a foot and a head, the threaded device having a cavity that is open at the foot and extends inside the shaft from the foot to the head; and
a baseplate configured to couple to the threaded device;
preparing the installation location for installation of the selected sensor assembly; and
installing the selected sensor assembly at the installation location.

2. The method of claim 1, further comprising coupling a sensor to the baseplate.

3. The method of claim 2, wherein the baseplate and the threaded device are coupled via magnetic coupling.

4. The method of claim 2, wherein the sensor includes a cable for communication with a second sensor.

5. The method of claim 1, wherein the threaded device includes a second cavity and a magnet installed in the second cavity.

6. The method of claim 1, wherein the baseplate and the threaded device are coupled via one of a group comprising: a screw, a fastener, a weld, or adhesive.

7. The method of claim 1, wherein the threaded device includes a hemi-spherically shaped top surface, and the baseplate includes a concave bottom surface configured to mate with the hemi-spherically shaped top surface.

8. The method of claim 1, wherein preparing the installation location includes creating a recess at the installation location.

9. The method of claim 1, wherein installing the selected sensor assembly includes using an insertion tool configured to minimize disturbance to consolidation of the installation location.

10. A geophysical sensor assembly comprising:
a threaded device having a shaft with a foot and a head, the threaded device having a cavity that is open at the foot and extends inside the shaft from the foot to the head; and
a baseplate configured to couple to the threaded device.

11. The assembly of claim 10, further comprising a sensor coupled to the baseplate.

12. The assembly of claim 11, wherein the baseplate and the threaded device are coupled via magnetic coupling.

13. The assembly of claim 11, wherein the sensor includes a cable for communication with a second sensor.

14. The assembly of claim 10, wherein the threaded device includes a second cavity and a magnet installed in the second cavity.

15. The assembly of claim 10, wherein the baseplate and the threaded device are coupled via one of a group comprising: a screw, a fastener, a weld, or adhesive.

16. The assembly of claim 10, wherein the threaded device includes a hemi-spherically shaped top surface, and the baseplate includes a concave bottom surface configured to mate with the hemi-spherically shaped top surface.

17. A method for deploying a geophysical sensor, comprising:
determining conditions at an installation location;
selecting a sensor assembly, the sensor assembly including:
a shaft with a foot and a head, the shaft having a cavity that is open at the foot and extends inside the shaft from the foot to the head; and
a head including a sensor and an interface;
preparing the installation location for installation of the selected sensor assembly; and
installing the selected sensor assembly at the installation location.

18. The method of claim 17, further comprising installing a collar on the head of the sensor assembly.

19. The method of claim 18, wherein the collar includes a cable for communication with a second sensor.

20. The method of claim 18, wherein the head includes a first interface and the collar includes a second interface communicatively coupled to the first interface.
